(19) United States
(12) Patent Application Publication
(10) Pub. No.: US 2025/0014050 A1
(43) Pub. Date: Jan. 9, 2025

(54) GHG EMISSION AMOUNT DERIVATION APPARATUS, GHG EMISSION AMOUNT DERIVATION METHOD, AND NON-TRANSITORY COMPUTER-READABLE MEDIUM

(71) Applicant: booost technologies,Inc., Tokyo (JP)

(72) Inventors: Yuzo NAGANO, Saitama (JP); Tadaaki HIRAHARA, Saitama (JP)

(21) Appl. No.: 18/805,609

(22) Filed: Aug. 15, 2024

Related U.S. Application Data
(63) Continuation of application No. PCT/JP2022/045521, filed on Dec. 9, 2022.

(30) Foreign Application Priority Data
Feb. 18, 2022 (JP) 2022-024220

(51) Int. Cl. G06Q 30/018

(52) U.S. Cl. CPC G06Q 30/018

(57) ABSTRACT

A greenhouse gas (GHG) emission amount derivation apparatus may include: an acquisition unit which acquires first activity amount data indicating an activity content and an activity amount for each activity content for which a GHG emission amount is derived; a selection unit which selects a first emission intensity format corresponding to a type of the first activity amount data from among a plurality of emission intensity formats predetermined for each type of activity amount data, the plurality of emission intensity formats indicating an emission intensity for each activity content; a decision unit which decides at least one emission intensity for each activity content indicated in the first activity amount data, based on the first emission intensity format; and a derivation unit which derives a GHG emission amount for each activity amount for each activity content indicated in the first activity amount data, based on the at least one emission intensity.

### BACKGROUND

### 1. TECHNICAL FIELD

The present invention relates to a GHG emission amount derivation apparatus, a GHG emission amount derivation method, and a non-transitory computer-readable medium.

### 2. RELATED ART

Patent Document 1 discloses a carbon dioxide emission amount calculation system that calculates a carbon dioxide emission amount for each electric device.

### PRIOR ART DOCUMENT

### Patent Document

Patent Document 1: Japanese Patent Application Publication No. 2013-25487

### BRIEF DESCRIPTION OF THE DRAWINGS

FIG. 1 is a diagram showing an example of a CSV file which is an example of activity amount data.

FIG. 2 is a diagram showing an example of a user interface illustrating an input screen of an emission intensity format.

FIG. 3 is a diagram showing a result of a calculation of a GHG emission amount after assigning activity amount data to the emission intensity format.

FIG. 4 is a diagram showing an example of a user interface of the emission intensity format.

FIG. 5 is a diagram showing a continuation of the user interface of the emission intensity format of FIG. 4.

FIG. 6 is a diagram showing an example of the user interface after activity amount data is read into a GHG emission amount derivation apparatus.

FIG. 7 is a diagram showing an example of the user interface of the emission intensity format when an activity content is electricity.

FIG. 8 is a diagram showing an example of the user interface after the activity amount data is read into the GHG emission amount derivation apparatus, when the activity content is electricity.

FIG. 9 is a diagram showing an example of the GHG emission amount derivation apparatus according to the present embodiment.

FIG. 10 is a diagram showing an example of each unit constituting the GHG emission amount derivation apparatus.

FIG. 11 is a flowchart showing an example of a procedure for deriving the GHG emission amount by the GHG emission amount derivation apparatus.

FIG. 12 is a flowchart showing an example of a procedure for creating a new emission intensity format by the GHG emission amount derivation apparatus.

FIG. 13 is a diagram showing an example of a hardware configuration.

### DESCRIPTION OF EXEMPLARY EMBODIMENTS

Hereinafter, the present invention will be described through embodiments of the present invention, but the following embodiments do not limit the present invention according to claims. In addition, not all of the combinations of features described in the embodiments are essential to the solution of the invention.

In recent years, it has been attempted to grasp and manage the entire corporate activities by deriving not only an emission amount of greenhouse gases (GHG emission amount) of a business operator itself but also a supply chain emission amount indicating GHG emission amounts of all supply chains relating to business activities. The supply chain emission amount represents the amount of GHG emission (in thousand tons of CO₂) that occur due to organizational activities of the business operator throughout the entire series of flow such as raw material procurement, manufacturing, distribution, sales, and disposal. The supply chain emission amount consists of scope 1, scope 2, and scope 3.

Scope 1 indicates a direct emission amount indicating an emission amount of a greenhouse gas directly emitted by the business operator itself. Scope 2 indicates an indirect emission amount (indirect emission of energy origin) indicating an emission amount of greenhouse gases indirectly emitted when the business operator purchases energy such as electricity, heat, and steam from another other company such as an electric power company and uses the purchased energy. Scope 3 indicates another indirect emission amount indicating an emission amount of greenhouse gases emitted by activities in the supply chain of the business operator, the another indirect emission amount not included in scope 1 and scope 2. Scope 3 is further classified into fifteen categories according to an activity content.

Category 1 indicates “purchased product/service”. Category 2 indicates “capital goods”. Category 3 indicates “fuel and energy related activities not included in scope 1 and scope 2”. Category 4 indicates “transport, conveyance (upstream)”. Category 5 indicates “waste from business activities”. Category 6 indicates “business trip”. Category 7 indicates “employer commutation”. Category 8 indicates “leased asset (upstream)”. Category 9 indicates “transport, delivery (downstream)”. Category 10 indicates “processing of sold products”. Category 11 indicates “use of sold products”. Category 12 indicates “disposal of sold products”. Category 13 indicates “leased asset (downstream)”. Category 14 indicates “franchise”. Category 15 indicates “investment”. Scope 3 further includes “others” indicating indirect GHG emission amount not included in the fifteen categories. The GHG emission amount corresponding to “others” includes, for example, a GHG emission amount related to the daily lives of employees or consumers and the like.

The supply chain emission amount is the sum of a scope 1 emission amount, a scope 2 emission amount, and a scope 3 emission amount. Through scope 1 to scope 3, a basic formula is activity amount x emission intensity. In the scope 3 emission amount, the basic formula is derived for each of the fifteen categories, and the results are summed for derivation. The activity amount in the basic formula is an amount regarding the scale of the activity of the business operator. For example, the usage of electricity, the amount of cargo transported, the amount of waste processed, various transaction amounts, or the like corresponds thereto. The activity amount is collected from various internal data, document data, industry average data, product design values, and the like. The emission intensity is a CO₂ emission amount per activity amount. For example, a CO₂ emission amount per kWh of electricity used, a CO₂ emission amount per ton-kilometer of cargo transported, a CO₂ emission amount per ton of waste incinerated, or the like corresponds thereto. The emission intensity is basically selected from an existing database and used, but there is also a method of directly measuring an emission amount or a method of receiving a derivation result of the emission amount from a business partner.

Incidentally, a processing load for a computer to derive the supply chain emission amount is not small. This is because the processing of deriving the supply chain emission amount by the computer involves a series of processing of extracting individual activity contents from a huge amount of various data of the business operator, classifying each activity content into three types of scopes, further classifying each activity content into a category in the case of scope 3, and further selecting an appropriate emission intensity. In particular, the emission intensity is diverse, and a processing load for the computer to select each appropriate emission intensity is large.

Therefore, according to the present embodiment, a GHG emission amount derivation apparatus, a GHG emission amount derivation method, and a program capable of reducing a processing load for calculating a supply chain emission amount (hereinafter, may be referred to as a GHG emission amount) are provided.

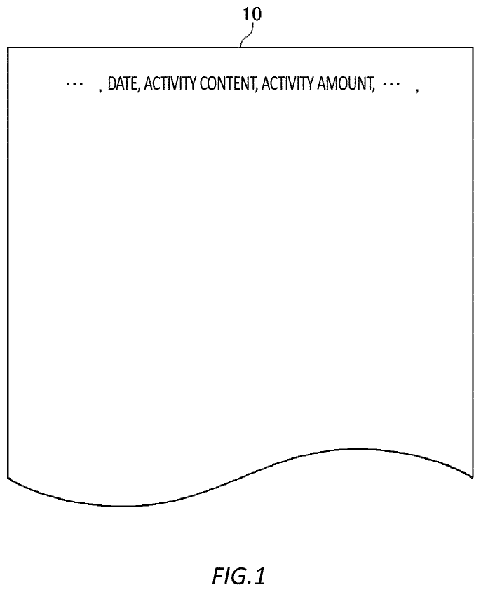

First, a flow of calculating a GHG emission amount in the present embodiment will be outlined. First, as illustrated in FIG. 1, a user prepares a file obtained by converting, into a CSV file 10, a file of an accounting system, a business system, a personnel system, an ERP system, or the like in which various types of data including the activity content and the activity amount of a business operator are recorded. The CSV file 10 is an example of activity amount data. The activity amount data may be a file in a predetermined format other than the CSV file as long as the activity amount data is data indicating the content of each item such as the activity content and the activity amount of the business operator in the predetermined format.

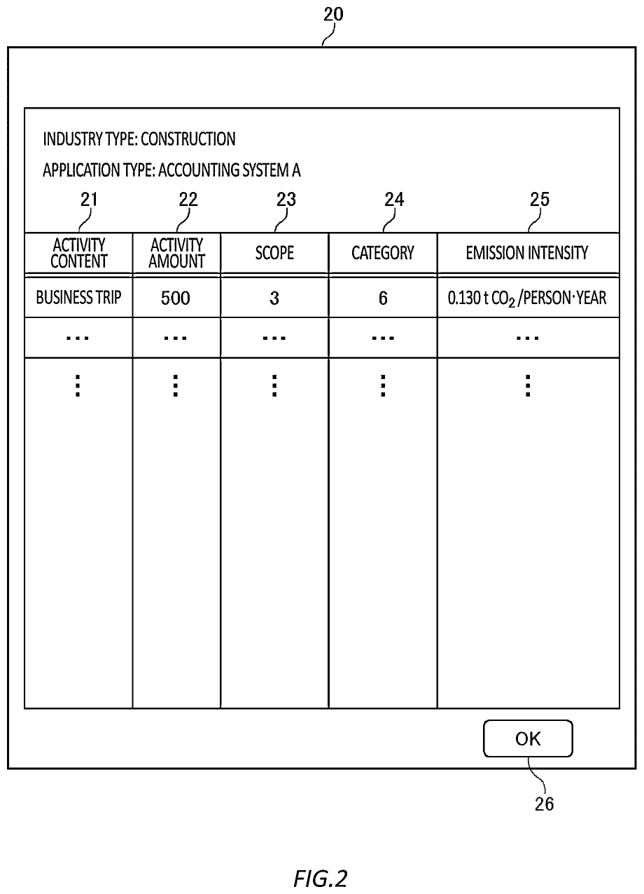

The GHG emission amount derivation apparatus reads a CSV file designated by the user, and displays an input screen for generating an emission intensity format corresponding to the CSV file. FIG. 2 shows an example of a user interface 20 showing the input screen for generating the emission intensity format. The user interface 20 includes at least items of an activity content 21, an activity amount 22, a scope 23, a category 24 (only when scope 3 is applicable), and an emission intensity 25.

Based on the CSV file 10, the GHG emission amount derivation apparatus receives an input of information necessary for each item from the user. When an OK button 26 at the bottom of the screen is pressed, the GHG emission amount derivation apparatus determines that the input has been completed. Accordingly, the activity content 21, the scope 23, the category 24, and the emission intensity 25 are associated. This emission intensity format 20 can be reused when a new CSV file is read into the GHG emission amount derivation apparatus. Here, a CSV file is read into the GHG emission amount derivation apparatus, but the present embodiment is not limited in this respect. For example, data may be individually input by a person into the GHG emission amount derivation apparatus. Alternatively, data may be directly acquired by a sensor or the like, or data may be directly acquired from another system by API cooperation.

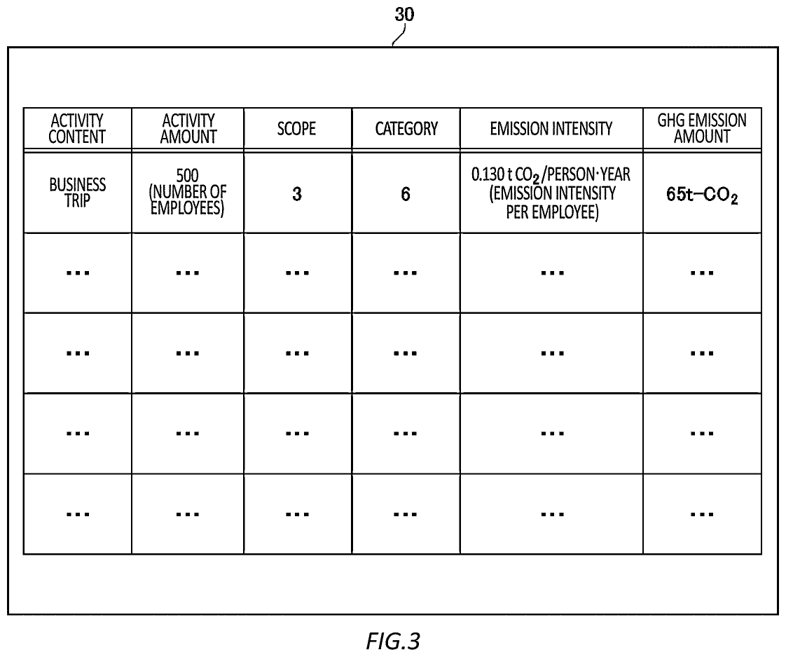

FIG. 3 shows an example of a user interface 30 showing a result screen of GHG emission amount calculation after an emission intensity format is applied to activity amount data. When the OK button 26 of the user interface 20 on the input screen illustrated in FIG. 2 is pressed, the GHG emission amount derivation apparatus calculates a GHG emission amount of each activity content by multiplying an activity amount of each activity content by an emission intensity of each activity content, and outputs the user interface 30.

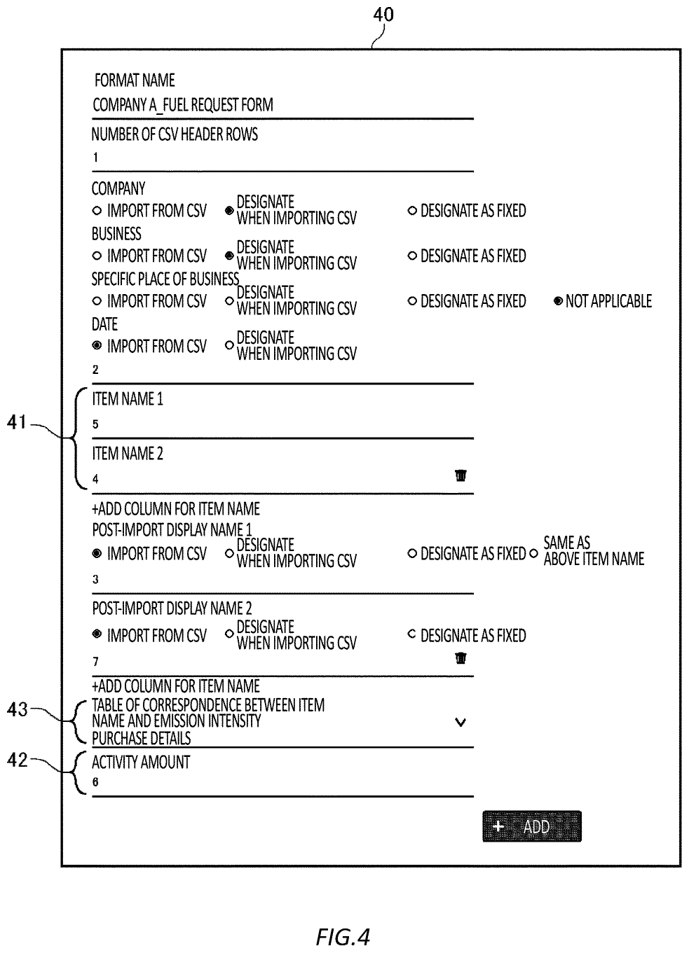

FIG. 4 is an example of a user interface 40 showing a creation screen for creating an emission intensity format in an application that embodies a GHG emission amount derivation apparatus. “Item name 1” and “Item name 2” shown in a region 41 of the creation screen 40 correspond to data representing the activity content. Here, the column number “5” in the CSV file is designated for “Item name 1”, and the column number “4” in the CSV file is designated for “Item name 2”. “Activity amount” shown in a region 42 of the user interface 40 corresponds to data representing the activity amount. Here, the column number “6” in the CSV file is designated for “Activity amount”. In the user interface 20 illustrated in FIG. 2, one column of activity content is included in one record for ease of understanding. However, the number of columns representing the activity content is not limited to one, and may be two or more. The number of columns representing the activity content may be, for example, three.

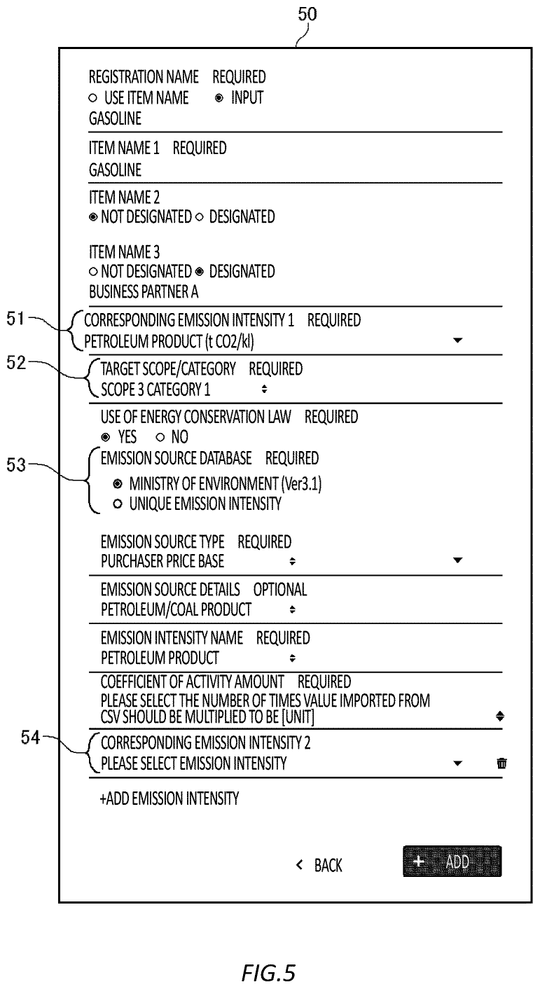

FIG. 5 shows an example of a user interface 50 of the creation screen of the emission intensity format displayed subsequent to the user interface 40 of the creation screen of the emission intensity format of FIG. 4. “Petroleum product (t CO₂/kl)” is designated for “Corresponding emission intensity 1” shown in a region 51 of the user interface 50. In a region 54 of the user interface 50, “Corresponding emission intensity 2” is shown. In this manner, a plurality of emission intensities can be designated for one activity content.

For example, in the present embodiment, three emission intensities can be designated. The association between the activity content and the emission intensity can be stored by using “Correspondence table between item name and emission intensity” shown in the region 43 of the creation screen 40. For example, for one activity content, a correspondence relationship between item names 1 to 3 and emission intensities 1 to 3 can be designated and stored. In addition, in the user interface 20 of the input screen of the emission intensity format of FIG. 2, an example is shown in which one scope, one category, and one emission intensity are associated with one activity content.

However, a plurality of scopes, a plurality of categories, and a plurality of emission intensities may be associated with one activity content. For example, one activity content of “gasoline sales” may be associated with category 10 (processing of sold products), category 11 (use of sold products), and category 12 (disposal of sold products) of scope 3, and be associated with their three respectively different emission intensities. This is because there is a case where in scope 3, a GHG emission amount is calculated from the same activity content across a plurality of categories. “Scope 3 and category 1” is designated for “Target scope/category” shown in a region 52 of the user interface 50. In “Emission source database” shown in a region 53 of the user interface 50, a database indicating the emission intensity corresponding to the activity content is shown. More specifically, in the region 53, an emission intensity database by the Ministry of the Environment and an emission intensity database by IDEA are shown. In the region 53, a unique emission intensity database indicating a unique emission intensity created and managed by the user is further shown. The user interface 40 and the user interface 50 which are the creation screens of the emission intensity format in FIGS. 4 and 5 are merely examples, and the items illustrated in FIGS. 4 and 5 may be omitted or added in practice.

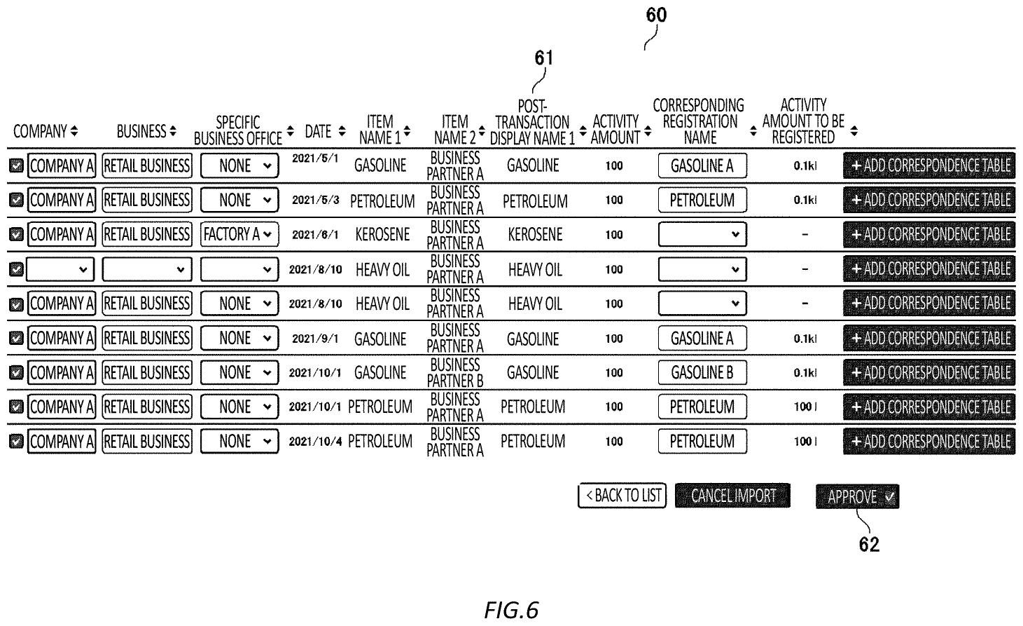

FIG. 6 shows an example of a user interface 60 after the CSV file has been assigned to the emission intensity format in FIGS. 4 and 5 and the CSV file has been read into the GHG emission amount derivation apparatus. In the user interface 60, two pieces of data representing the activity content are included as “Item name 1” and “Item name 2”, and thus “Item name 1” gasoline+“Item name 2” business partner A and “Item name 1” gasoline+“Item name 2” business partner B are displayed. In this way, even for the same gasoline, the GHG emission amount derivation apparatus can calculate each GHG emission amount by distinguishing an activity content for each business partner. By including a plurality of columns representing the activity content, the data representing activity contents can be set more finely to calculate the GHG emission amount. In a region 61 of the user interface 60, a display name when the CSV file is imported to the GHG emission amount derivation apparatus is displayed. When a plurality of items are designated as activity contents in the region 61 of the user interface 60, an item to be displayed as the display name is designated among the items. Here, “5”, which is the same column number as the column number designated in item name 1, is designated. After confirming that the CSV file has been correctly read, the user presses an “Approve” button 62. Then, the GHG emission amount derivation apparatus calculates a GHG emission amount by multiplying the activity amount by the emission intensity.

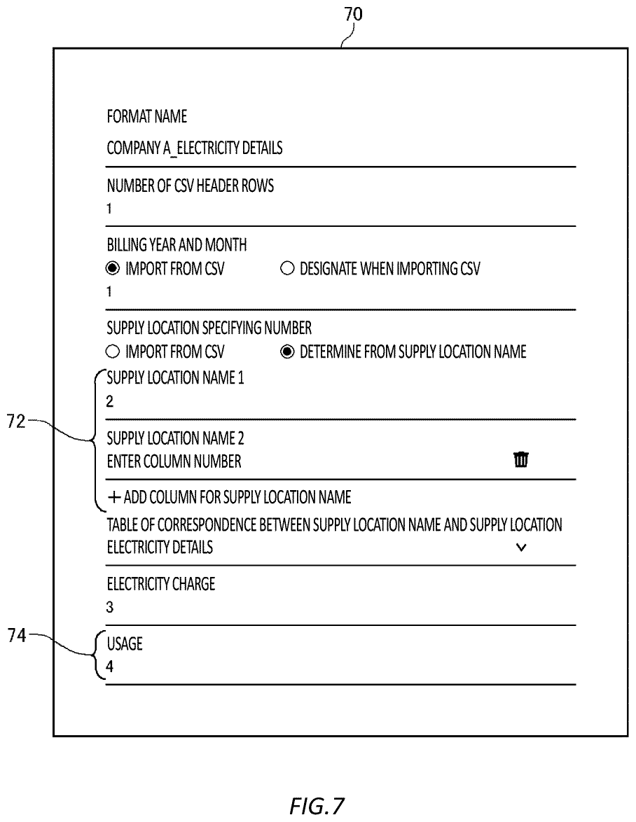

FIG. 7 shows an example of a user interface 70 of a creation screen for an emission intensity format particularly when the activity content is electricity. “Supply location name 1” and “Supply location name 2” shown in a region 72 of the user interface 70 correspond to data representing the activity content. Here, the column number “2” in the CSV file is designated for “Supply location name 1”.

In the case of electricity, for example, three supply location names can be included for one supply location specifying number (22-digit number). Again, as described above with reference to FIG. 4, the number of columns representing the activity content is not limited to one. For example, even for the same Kanto area, the GHG emission amount can be calculated for each of the store A and the store B, such as “Supply location name 1” store A+“Supply location name 2” Kanto area and “Supply location name 1” store B+“Supply location name 2” Kanto area.

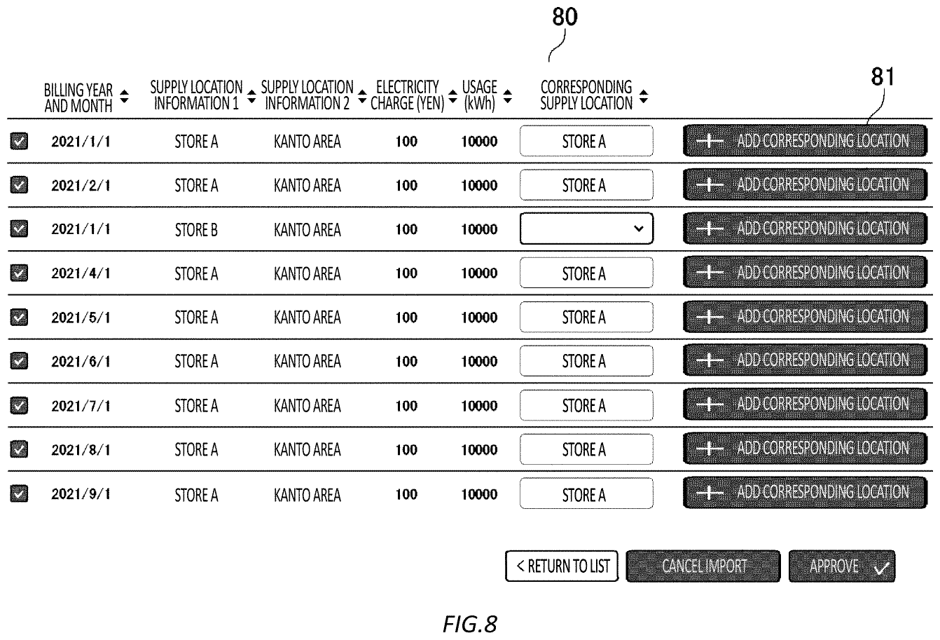

Even in the case of electricity, a plurality of scopes, a plurality of categories, and a plurality of emission intensities may be associated with one activity content. The “Usage” shown in a region 74 of the user interface 70 corresponds to data representing the activity amount. Here, the column number 4 in the CSV file is designated for “Usage”. FIG. 8 shows an example of a user interface 80 after the CSV file has been assigned to the emission intensity format via the user interface 70 shown in FIG. 7 and the CSV file has been read into the GHG emission amount derivation apparatus. “Corresponding location addition” in a region 81 of the user interface 80 is for adding supply location information.

The above is an overview of the flow of creating the emission intensity format and calculating the GHG emission amount in the present embodiment. Once the emission intensity format is created, any subsequent user, even if she/he is different from the original user, is presented with the scope, the category, and the emission intensity from the created emission intensity format if the user has the same user industry type and the same application type as those of a user who has previously created the emission intensity format. Accordingly, it is possible to save time and effort for the user to manually assign the scope, the category, and the emission intensity to each activity content individually.

It is sufficient if the user industry type is input as user information at the time of user registration to the GHG emission amount derivation apparatus. In addition, for the application type, it is only required to designate a CSV file creation source application in the GHG emission amount derivation apparatus.

When the scope, the category, and the emission intensity are presented from the created emission intensity format, for example, a plurality of emission intensity formats by a plurality of users may be aggregated, association sets of the scope, the category, and the emission intensity having the same industry type, the same application type, and the same activity content may be sorted and counted, and for example, top five sets may be presented in descending order of the number of counts. In this way, the user can reuse the existing emission intensity format to quickly read the CSV file into the GHG emission amount derivation apparatus.

The GHG emission amount derivation apparatus may specify the scope, the category, and the emission intensity to be presented according to a learning model trained using training data with the user industry type and the activity content as input and the scope, the category, and the emission intensity as output. The learning model in this case is a classifier. When the industry type and the activity content are input to the trained learning model, the GHG emission amount derivation apparatus may derive reliabilities of association sets of a plurality of scopes, categories, and emission intensities, and present, for example, top five sets in descending order of the reliability. In this way, the user only needs to select an appropriate set from the presented set of scopes, categories, and emission intensities without creating the emission intensity format.

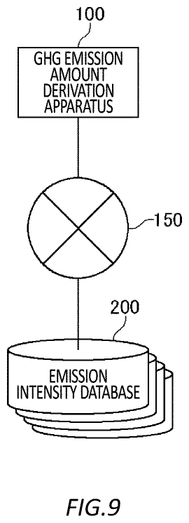

Hereinafter, specific contents according to the present embodiment will be described. FIG. 9 shows an example of a GHG emission amount derivation apparatus 100 according to the present embodiment. The GHG emission amount derivation apparatus 100 communicates with an emission intensity database 200 via a network 150. The GHG emission amount derivation apparatus 100 calculates a GHG emission amount by multiplying an activity amount by an emission intensity registered in the emission intensity database 200. The emission intensity database is, for example, an emission intensity database by the Ministry of the Environment, an emission intensity database by IDEA, an environmental load intensity data book (3EID) by input-output tables, an LCA database by the LCA Society of Japan, and the like.

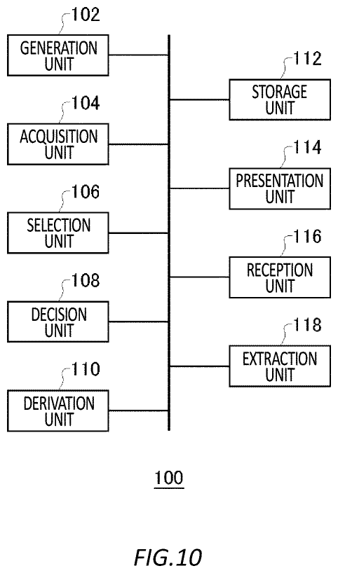

FIG. 10 shows an example of each unit constituting the GHG emission amount derivation apparatus 100. The GHG emission amount derivation apparatus 100 includes a generation unit 102, an acquisition unit 104, a selection unit 106, a decision unit 108, a derivation unit 110, a storage unit 112, a presentation unit 114, a reception unit 116, and an extraction unit 118. The GHG emission amount derivation apparatus 100 according to the present embodiment may be a computer. The generation unit 102, the acquisition unit 104, the selection unit 106, the decision unit 108, the derivation unit 110, the presentation unit 114, the reception unit 116, and the extraction unit 118 may be implemented by a central processing unit. The storage unit 112 may be implemented by a memory.

The acquisition unit 104 acquires first activity amount data indicating an activity content and an activity amount for each activity content for which a GHG emission amount is derived. The first activity amount data includes an activity content and an activity amount for each activity content. The activity amount data may be, for example, a file (for example, a CSV file) obtained by converting a file of an accounting system or the like into a format readable by the GHG emission amount derivation apparatus 100. The activity content represents an activity of a business operator directly or indirectly involved in GHG emission. The activity content may be, for example, “business trip by employees”. For example, when it is assumed that the deriving method is to derive, from the number of employees, a GHG emission amount due to a business trip, the activity amount may be, for example, “500 people (the number of employees)”.

The selection unit 106 selects a first emission intensity format corresponding to the type of the first activity amount data from among a plurality of emission intensity formats stored in the storage unit 112 and predetermined for each type of activity amount data, the plurality of emission intensity formats indicating an emission intensity for each activity content. The type of the activity amount data corresponds to the type of the application used to create the activity amount data. In addition, the type of the activity amount data corresponds to the industry type of an activity entity. The activity entity is an entity that performs an activity of directly or indirectly emitting a GHG, and is, for example, a business operator that wishes to derive a GHG emission amount associated with its own activity.

For example, the type of the activity amount data is specified by the user industry type and the type of the creation source application of the activity amount data. The application may be a program for causing an accounting system, a business system, a personnel system, or an ERP system to operate on a computer. The type of the application of the creation source may be indicated in the activity amount data. The user industry type may also be indicated in the activity amount data. Alternatively, the storage unit 112 may store user identification information for identifying the user and industry type information indicating the user industry type in association with each other. The activity amount data may include the user identification information. Then, the selection unit 106 may specify the type of the application of the creation source with reference to the activity amount data, and specify the user industry type corresponding to the user identification information with reference to the storage unit 112. The storage unit 112 may store the application type used by the user in association with the user identification information. The selection unit 106 selects, as the first emission intensity format, an emission intensity format which has the same user industry type and the same application type of the creation source of the activity amount data, from among a plurality of emission intensity formats created in advance by a plurality of users.

The decision unit 108 decides at least one emission intensity for each activity content indicated in the first activity amount data, based on the first emission intensity format. The first emission intensity format indicates the emission intensity in association with the activity content. When the activity content is “business trip by employees”, the first emission intensity format indicates “0.103 t CO₂/person·year”, which is an emission intensity per employee, as an emission intensity of “business trip by employees”.

Based on at least one emission intensity, the derivation unit 110 derives a GHG emission amount for each activity amount for each activity content indicated in the first activity amount data. The derivation unit 110 derives, for example, number of employees x emission intensity per employee=500 persons×0.130 t CO₂/person·year=65 t CO₂ as the GHG emission amount of the activity content “business trip by employees”.

The activity content includes vendor information regarding a vendor relating to the activity. The vendor information is, for example, information of a business partner, a purchase destination of electricity, and the like. The activity content includes location information regarding a place relating to the activity. The location information is, for example, information such as a store name, a building name, and a geographic area.

The GHG emission amount includes at least another indirect emission amount indicating the GHG emission amount emitted by the activity of the business operator, the another indirect emission amount not included in the indirect emission amount indicating the GHG emission amount indirectly emitted by a business operator in purchasing energy. As described above, the scope 1 emission amount, the scope 2 emission amount, and the scope 3 emission amount are included in the supply chain emission amount. The indirect emission amount indicating the GHG emission amount indirectly emitted by the business operator purchasing energy is the scope 2 emission amount. The another indirect emission amount indicating the GHG emission amount emitted by the activities of the business operator is the scope 3 emission amount.

When the activity content corresponds to the target of the another indirect emission amount, the emission intensity format indicates at least one emission intensity corresponding to at least one category corresponding to an activity content of the another indirect emission amount. That is, when the activity content corresponds to scope 3, the emission intensity format indicates at least one emission intensity corresponding to at least one category corresponding to the activity content of scope 3. In particular, in the case of scope 3, a plurality of categories and a plurality of emission intensities may be associated with one activity content.

The presentation unit 114 presents an activity content for which the decision unit 108 cannot decide at least one emission intensity based on the first emission intensity format, among the activity contents indicated in the first activity amount data. There may be a case where the decision unit 108 cannot decide the emission intensity among the activity contents indicated in the first activity amount data, from the selected first emission intensity format. This may occur when the activity content designated in the selected first emission intensity format which has the same user industry type and the same application type does not match the activity content of the first activity amount data.

For example, when the activity content designated in the selected first emission intensity format is not “business trip by employees” but “gasoline sales”, the decision unit 108 cannot decide the emission intensity. Alternatively, even when the activity content designated in the selected first emission intensity format which has the same user industry type and the same application type is the same as the activity content of the first activity amount data, in a case where the units of the activity amounts do not match, the decision unit 108 cannot decide the emission intensity. When it is defined in the first emission intensity format that a GHG emission amount due to a business trip is derived from the number of employees, the activity amount is the number of employees.

On the other hand, when the first activity amount data indicates a travel distance as the activity amount of the business trip by employees, in the first emission intensity format, an emission intensity for a business trip expense amount needs to be associated with the activity content of the business trip by employees. However, in the first emission intensity format, the emission intensity for the business trip expense amount is not associated therewith. In this case, the decision unit 108 cannot decide the emission intensity for the business trip by employees.

The reception unit 116 receives the emission intensity for the presented activity content from the user. For the presented activity content, that is, the business trip by employees, the user designates, for example, an emission intensity “0.00137 kg CO₂/yen” per business trip expense amount which is an emission intensity of the passenger railway.

Optionally, when the presentation unit 114 presents the activity content for which a decision cannot be made based on the first emission intensity format, another emission intensity format which is the same regarding only one of the type of the application and the industry type of the activity entity and has the same designated activity content may be searched for. When the another emission intensity format is found, the presentation unit 114 may present, to the user, the emission intensity input to the another emission intensity format together with the activity content for which a decision cannot be made. If the emission intensity input to the another emission intensity format is appropriate, the user may select the emission intensity.

The reception unit 116 may receive, from the user, designation of an emission intensity database to be referred to for deciding the emission intensity for the presented activity content, from among a plurality of emission intensity databases indicating the emission intensity for each activity content. For example, the user may designate the emission intensity database from among the emission intensity database by the Ministry of the Environment, the emission intensity database by IDEA, the environmental load intensity data book (3EID) by input-output tables, and the LCA database by the LCA Society of Japan which are displayed. Alternatively, the user may designate a unique emission intensity database. Further, the reception unit 116 may receive, from the user, the emission intensity for the presented activity content from among the emission intensities indicated in the received emission intensity database.

The extraction unit 118 extracts, from another existing emission intensity format corresponding to the type of the first activity amount data, at least one set of at least one category and at least one emission intensity related to another indirect emission amount, the at least one set corresponding to the activity content for which the decision unit 108 cannot make a decision based on the first emission intensity format among the activity contents indicated in the first activity amount data. When the decision unit 108 cannot decide the emission intensity based on the selected first emission intensity format, the extraction unit 118 extracts at least one set of at least one category and at least one emission intensity from another existing emission intensity format which has the same user industry type, the same application type, and the same activity content and is different from the first emission intensity format, and the presentation unit 114 presents the extracted at least one set to the user. The reception unit 116 receives, from the user, a set for the activity content for which a decision cannot be made, from among the at least one set. The user selects an appropriate set from among the presented at least one set of at least one category and at least one emission intensity and designates the set to the activity content for which a decision cannot be made.

The extraction unit 118 may sort and count association sets of the category and the emission intensity for each same set from among a plurality of other existing emission intensity formats having the same industry type, the same application type, and the same activity content, and extract sets up to a specific top rank in descending order of the number of counts, and the presentation unit 114 may display the extracted sets up to the specific top rank. For example, the presentation unit 114 may present top five sets. Alternatively, the extraction unit 118 may sort and count association sets of the category and the emission intensity for each same set, from among a plurality of other existing emission intensity formats having the same industry type and the same activity content or the same application type and the same activity content, and extract top five sets in descending order of the number of counts, and the presentation unit 114 may present the top five sets. Alternatively, the extraction unit 118 may sort and count association sets of the category and the emission intensity for each same set from among a plurality of other existing emission intensity formats having the same activity content, and extract top five sets in descending order of the number of counts, and the presentation unit 114 may present the top five sets.

Heretofore, the description has been given of a case where the GHG emission amount derivation apparatus derives the GHG emission amount by deciding an emission intensity from the emission intensity formats created in advance. On the other hand, in the following, a case where an emission intensity format is newly generated when the user reads new activity amount data into the GHG emission amount derivation apparatus will be described. It is assumed that the activity content in the activity amount data corresponds to an arbitrary category of scope 3.

The acquisition unit 104 acquires new activity amount data indicating an activity content and an activity amount for each activity content for which a GHG emission amount is derived. The acquisition unit 104 may acquire the activity amount data corresponding to the file name designated by the user from the storage unit 112. The acquisition unit 104 may acquire, via the network 150, the new activity amount data attached to an electronic mail or the like and transmitted from another apparatus. The extraction unit 118 may specify the type of the creation source application with reference to the new activity amount data, and specify the user industry type corresponding to the user identification information with reference to the storage unit 112, thereby specifying the type of the new activity amount data. The extraction unit 118 extracts, from the existing emission intensity format corresponding to the type of the new activity amount data, at least one set of at least one category and at least one emission intensity related to another indirect emission amount, the at least one set corresponding to each activity content indicated in the new activity amount data. Next, the generation unit 102 generates a new emission intensity format for the new activity amount data by specifying, from among the at least one set, one set for each activity content indicated in the new activity amount data according to an instruction of the user.

Out of a plurality of emission intensity formats created in advance by a plurality of users, from the emission intensity format which has the same user industry type and the same application type, the extraction unit 118 extracts at least one set of at least one category and at least one emission intensity having the same activity content, and the presentation unit 114 presents the extracted at least one set to the user.

The extraction unit 118 may sort and count associations sets of the category and the emission intensity for each same set, and extract sets up to a specific top rank in descending order of the number of counts, and the presentation unit 114 may present the extracted sets up to the specific top rank. For example, the presentation unit 114 may present top five sets. When at least one set of at least one category and at least one emission intensity having the same activity content cannot be extracted from an existing emission intensity format having the same user industry type, the same application type, and the same activity content, the extraction unit 118 may extract at least one set of at least one category and at least one emission intensity having the same activity content from among a plurality of existing emission intensity formats each having a different application type and the same industry type.

Alternatively, the extraction unit 118 may extract at least one set of at least one category and at least one emission intensity having the same activity content from among a plurality of existing emission intensity formats each having a different user industry type and the same application type. When still at least one set cannot be extracted, the extraction unit 118 may extract at least one set of at least one category and at least one emission intensity having the same activity content from among an existing emission intensity format having a different user industry type and a different application type. The user designates an appropriate set for the activity content from among the presented at least one set.

If the extraction unit 118 cannot extract a set of at least one category and at least one emission intensity, the reception unit 116 may receive, from the user, designation of an appropriate set of the category and the emission intensity for the activity content. At this time, the presentation unit 114 may further present the user with an emission intensity database to be referred to for deciding the emission intensity for the activity content. The generation unit 102 generates a new emission intensity format for the new activity amount data by specifying a set for the activity content according to the designation of the user.

In the above description, an example has been described in which the extraction unit 118 extracts, from among a plurality of existing emission intensity formats, at least one set of at least one category and at least one emission intensity, the at least one set having the same activity content and being top sets in descending order of the number of counts. On the other hand, a mode in which the extraction unit 118 extracts at least one set of at least one category and at least one emission intensity according to the activity content indicated in the activity amount data by a trained learning model will be described below.

The extraction unit 118 may extract, as at least one set, a predetermined number of sets in descending order of reliability according to a learning model obtained by machine learning a combination of the type of the activity amount data and the activity content which are specified from the existing emission intensity format, and at least one category and at least one emission intensity related to another indirect emission amount, the combination being as training data. The learning model may be a deep learning model.

The extraction unit 118 may derive the reliability by using output of the Softmax function or the like. For example, by using training data with the user industry type and the activity content as input and the scope, the category, and the emission intensity as output, the generation unit 102 may train, according to a supervised learning algorithm, a learning model showing a relationship between the type of the activity amount data and the activity content, and at least one category and at least one emission intensity related to another indirect emission amount, generate a trained learning model, and store the trained learning model in the storage unit 112. The algorithm may be an algorithm in any manner such as a neural network, a support vector machine, multiple regression analysis, or a decision tree. Here, data input to the learning model may be individual input by a person or direct acquisition of data by a sensor or the like. When the industry type and the activity content are input, the extraction unit 118 may derive the reliabilities of association sets of the scope, the category, and the emission intensity according to the trained learning model, and extract sets up to a specific top rank in descending order of the reliability of the set. For example, the extraction unit 118 may extract top five sets.

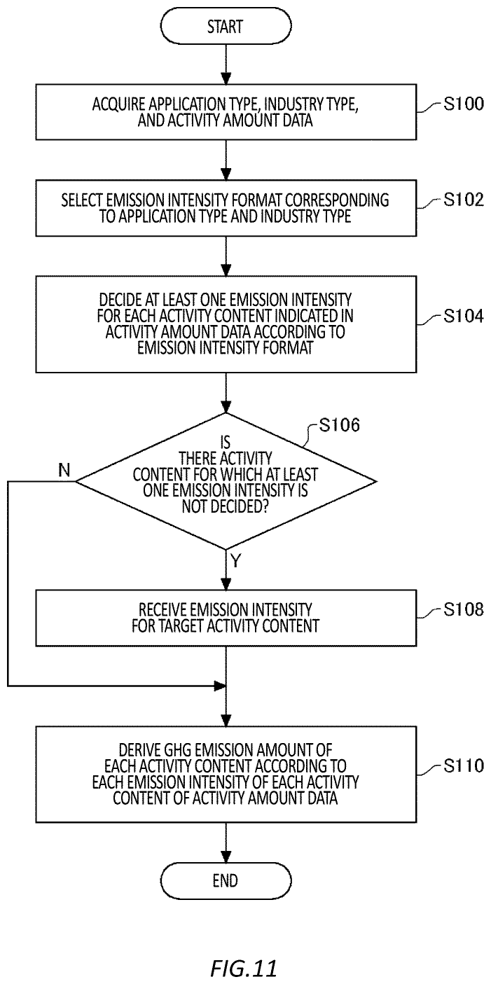

FIG. 11 is a flowchart showing an example of a procedure for deriving the GHG emission amount by the GHG emission amount derivation apparatus according to the present embodiment.

In S100, the acquisition unit 104 acquires the application type, the user industry type, and the activity amount data. The acquisition unit 104 may acquire the application type of the creation source with reference to the activity amount data, and acquire the user industry type corresponding to the user identification information with reference to the storage unit 112.

In S102, the selection unit 106 selects the emission intensity format corresponding to the application type and the user industry type from a plurality of existing emission intensity formats created in advance. The selection unit 106 selects the emission intensity format having the same user industry type and the same application type from the plurality of existing emission intensity formats.

In S104, the decision unit 108 decides at least one emission intensity for each activity content indicated in the activity amount data according to the selected emission intensity format. When the activity content corresponds to scope 3, the decision unit 108 may decide the emission intensity one by one for each of a plurality of categories corresponding to the activity content.

In S106, the decision unit 108 decides whether there is an activity content for which at least one emission intensity has not been decided.

If yes, the process proceeds to S108. In S108, the reception unit 116 receives, from the user, at least one emission intensity for the undecided activity content. Here, out of a plurality of existing emission intensity formats, from emission intensity formats having the same user industry type and the same application type, the extraction unit 118 may sort and count association sets of the category and the emission intensity for each same set, and extract sets up to a specific top rank in descending order of the number of counts, and the presentation unit 114 may present the extracted sets up to the specific top rank. Then, the reception unit 116 may receive at least one emission intensity by receiving a set for the undecided activity content from among the presented sets.

If no, the process proceeds to S110. In S110, the derivation unit 110 derives the GHG emission amount of each activity content according to each emission intensity of each activity content of the activity amount data.

According to the above procedure, an optimal emission intensity format for new activity amount data can be selected from among existing emission intensity formats in consideration of the user industry type and the creation source application type of the activity amount data. Thus, it is possible to reduce the time and effort for manually selecting appropriate emission intensities one by one for new activity amount data and newly creating an emission intensity format. In addition, it is possible to reduce the processing load of the GHG emission amount derivation apparatus 100 when creating a new emission intensity format.

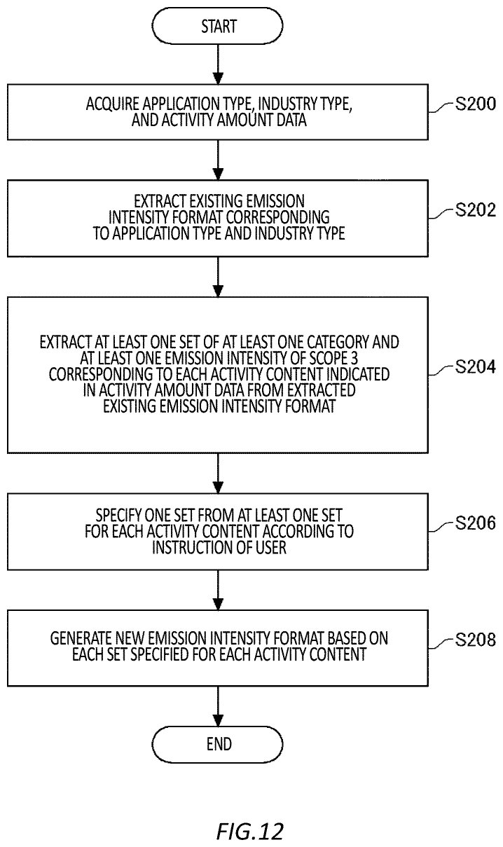

FIG. 12 is a flowchart showing an example of a procedure for creating a new emission intensity format by the GHG emission amount derivation apparatus 100 according to the present embodiment.

In S200, the acquisition unit 104 acquires the application type, the user industry type, and the activity amount data. The acquisition unit 104 may acquire the application type of the creation source with reference to the activity amount data, and acquire the user industry type corresponding to the user identification information with reference to the storage unit 112.

In S202, the extraction unit 118 extracts an existing emission intensity format corresponding to the application type and the user industry type. The extraction unit 118 may extract an existing emission intensity format having the same user industry type and the same application type among a plurality of existing emission intensity formats.

In S204, the extraction unit 118 extracts at least one set of at least one category and at least one emission intensity of scope 3 corresponding to each activity content indicated in the activity amount data from the extracted existing emission intensity format. The extraction unit 118 may sort and count association sets of the category and the emission intensity of scope 3 for each same set from among the existing emission intensity formats, and extract sets up to a specific top rank in descending order of the number of counts. The extraction unit 118 may extract, as at least one set, a predetermined number of sets in descending order of reliability according to a trained learning model showing a relationship between the type and the activity content of the activity amount data and at least one category and at least one emission intensity of scope 3.

In S206, the generation unit 102 specifies one set from at least one set for each activity content according to an instruction of the user. The presentation unit 114 may present at least one set of at least one category and at least one emission intensity of scope 3 extracted by the extraction unit 118 for each activity content. The reception unit 116 may receive, as the instruction of the user, one set for each activity content from among at least one set presented for each activity content.

In S208, the generation unit 102 generates a new emission intensity format based on each set specified for each activity content.

As in the above procedure, even when a new emission intensity format is created, at least one set of at least one category and at least one emission intensity of scope 3 is presented for each activity content according to the existing emission intensity format. It is possible to reduce the time and effort for manually selecting appropriate emission intensities one by one for the new activity amount data and newly creating an emission intensity format.

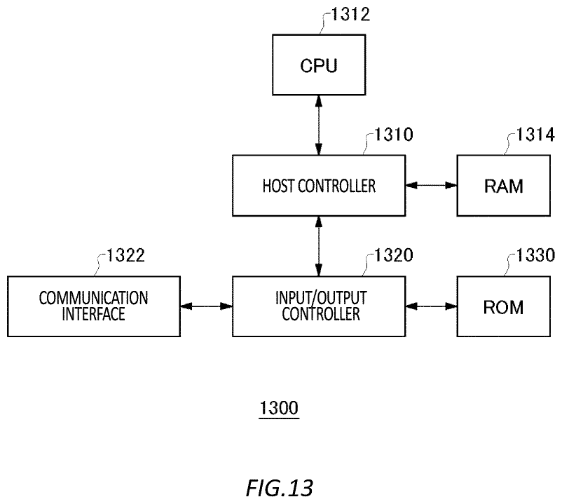

FIG. 13 shows an example of a computer 1300 in which a plurality of aspects of the present invention may be embodied in whole or in part. Programs installed in the computer 1300 can cause the computer 1300 to function as operations associated with the apparatus according to the embodiments of the present invention or one or more “units” of the apparatus. Alternatively, the programs can cause the computer 1300 to execute the operations or the one or more “units”. The programs can cause the computer 1300 to execute a process according to the embodiments of the present invention or steps of the process. Such programs may be executed by a CPU 1312 to cause the computer 1300 to perform specific operations associated with some or all of the blocks in the flowcharts and block diagrams described in the present specification.

The computer 1300 according to the present embodiment includes the CPU 1312 and a RAM 1314, which are mutually connected by a host controller 1310. The computer 1300 also includes a communication interface 1322 and an input/output unit, which are connected to the host controller 1310 via an input/output controller 1320. The computer 1300 also includes an ROM 1330. The CPU 1312 operates according to the programs stored in the ROM 1330 and the RAM 1314, thereby controlling each unit.

The communication interface 1322 communicates with other electronic devices via a network. A hard disk drive may store the programs and data used by the CPU 1312 in the computer 1300. The ROM 1330 stores therein boot programs or the like executed by the computer 1300 at the time of activation, and/or programs depending on hardware of the computer 1300. A program is provided via a computer-readable recording medium such as a CD-ROM, a USB memory, or an IC card, or via a network. The programs are installed in the RAM 1314 or the ROM 1330 which is also an example of the computer-readable recording medium, and executed by the CPU 1312. The information processing described in these programs is read by the computer 1300, and provides cooperation between the programs and the various types of hardware resources. The apparatus or method may be configured by implementing operations or processing of information according to use of the computer 1300.

For example, if communication is executed between the computer 1300 and an external device, the CPU 1312 may execute a communication program loaded in the RAM 1314 and instruct the communication interface 1322 to perform communication processing based on processing described in the communication program. The communication interface 1322, under the control of the CPU 1312, reads transmission data stored in a transmission buffer region provided in a recording medium such as the RAM 1314 or the USB memory, transmits the read transmission data to the network, or writes reception data received from the network to a reception buffer region or the like provided on the recording medium. In addition, the CPU 1312 may cause all or necessary portion of a file or a database stored in an external recording medium such as a USB memory, to be read by the RAM 1314, and execute various types of processing on the data on the RAM 1314. Next, the CPU 1312 may write back the processed data into an external recording medium.

Various types of information, such as various types of programs, data, tables, and databases, may be stored in the recording medium to undergo information processing. The CPU 1312 may execute, on the data read from the RAM 1314, various types of processing, including various types of operations designated by an instruction sequence of a program, which are described throughout the present disclosure, information processing, a condition judgment, a conditional branch, an unconditional branch, information search/replacement, and the like, and write back the result to the RAM 1314. In addition, the CPU 1312 may search for information in a file, a database, or the like in the recording medium. For example, when a plurality of entries, each having an attribute value of a first attribute associated with an attribute value of a second attribute, is stored in the recording medium, the CPU 1312 may retrieve, out of the plurality of entries, an entry with the attribute value of the first attribute specified that meets a condition, read the attribute value of the second attribute stored in said entry, and thereby acquiring the attribute value of the second attribute associated with the first attribute meeting a predetermined condition.

The programs or software modules described above may be stored in a computer readable storage medium on or near the computer 1300. In addition, a recording medium such as a hard disk or a RAM provided in a server system connected to a dedicated communication network or the Internet can be used as the computer readable storage medium, so that the programs are provided to the computer 1300 via the network.

Computer readable medium may include any tangible device that can store instructions for execution by a suitable device. As a result, the computer readable medium having instructions stored therein includes an article of manufacture including instructions which can be executed to create means for performing operations specified in the flowcharts or block diagrams. Examples of the computer readable medium may include an electronic storage medium, a magnetic storage medium, an optical storage medium, an electromagnetic storage medium, a semiconductor storage medium, and the like. More specific examples of the computer readable medium may include a floppy disk, a diskette, a hard disk, a random access memory (RAM), a read only memory (ROM), an erasable programmable read only memory (EPROM or a flash memory), an electrically erasable programmable read only memory (EEPROM (registered trademark)), a static random access memory (SRAM), a compact disc read only memory (CD-ROM), a digital versatile disk (DVD), a Blu-ray (registered trademark) disk, a memory stick, an integrated circuit card, and the like.

Computer readable instructions may include either a source code or an object code written in any combination of one or more programming languages. The source code or the object code includes a conventional procedural programming language. The conventional procedural programming language may be assembler instructions, instruction-set-architecture (ISA) instructions, machine instructions, machine dependent instructions, microcode, firmware instructions, state-setting data, or an object-oriented programming language such as Smalltalk (registered trademark), JAVA (registered trademark), C++, etc., and programming languages, such as the “C” programming language or similar programming languages. Computer-readable instructions may be provided to a processor of a general-purpose computer, special purpose computer, or other programmable data processing apparatus, or to programmable circuitry, locally or via a local area network (LAN), a wide area network (WAN) such as the Internet, etc. The processor or the programmable circuitry may execute the computer readable instructions to create means for performing operations specified in the flowcharts or block diagrams. Examples of the processor include a computer processor, a processing unit, a microprocessor, a digital signal processor, a controller, a microcontroller, and the like.

While the present invention has been described with the embodiments, the technical scope of the present invention is not limited to the above-described embodiments. It is apparent to persons skilled in the art that various alterations and improvements can be added to the above-described embodiments. It is also apparent from the scope of the claims that the embodiments added with such alterations or improvements can be included in the technical scope of the present invention.

The operations, procedures, steps, stages, or the like of each process performed by a device, system, program, and method shown in the claims, embodiments, or diagrams can be realized in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

100: GHG emission amount derivation apparatus;
200: emission intensity database;
102: generation unit;
104: acquisition unit;
106: selection unit;
108: decision unit;
110: derivation unit;
112: storage unit;
114: presentation unit;
116: reception unit;
118: extraction unit;
1300: computer;
1310: host controller;
1312: CPU;
1314: RAM;
1320: input/output controller;
1322: communication interface; and
1330: ROM.

What is claimed is:

1. A greenhouse gas (GHG) emission amount derivation apparatus comprising:
an acquisition unit which acquires first activity amount data indicating an activity content and an activity amount for each activity content for which a GHG emission amount is derived;
a selection unit which selects a first emission intensity format corresponding to a type of the first activity amount data from among a plurality of emission intensity formats predetermined for each type of activity amount data, the plurality of emission intensity formats indicating an emission intensity for each activity content;
a decision unit which decides at least one emission intensity for each activity content indicated in the first activity amount data, based on the first emission intensity format; and
a derivation unit which derives a GHG emission amount for each activity amount for each activity content indicated in the first activity amount data, based on the at least one emission intensity.

2. The GHG emission amount derivation apparatus according to claim 1, wherein a type of the activity amount data corresponds to a type of an application used to create activity amount data.

3. The GHG emission amount derivation apparatus according to claim 2, wherein a type of the activity amount data further corresponds to an industry type of an activity entity.

4. The GHG emission amount derivation apparatus according to claim 1, wherein the activity content includes vendor information regarding a vendor relating to an activity.

5. The GHG emission amount derivation apparatus according to claim 1, wherein the activity content includes location information regarding a place relating to an activity.

6. The GHG emission amount derivation apparatus according to claim 1, comprising:
a presentation unit which presents, among activity contents indicated in the first activity amount data, an activity content for which the decision unit is not able to decide at least one emission intensity based on the first emission intensity format; and
a reception unit which receives, from a user, an emission intensity for the activity content presented.

7. The GHG emission amount derivation apparatus according to claim 6, wherein
the reception unit
receives, from the user, designation of an emission intensity database to be referred to for deciding the emission intensity for the activity content presented, from among a plurality of emission intensity databases indicating an emission intensity for each activity content, and receives, from the user, the emission intensity for the activity content presented, from among emission intensities indicated in the emission intensity database received.

8. The GHG emission amount derivation apparatus according to claim 1, wherein
the GHG emission amount includes at least another indirect emission amount indicating a GHG emission amount emitted by an activity of a business operator, the another indirect emission amount not included in an indirect emission amount indicating a GHG emission amount indirectly emitted by a business operator purchasing energy, and
when an activity content corresponds to a target of the another indirect emission amount, the emission intensity format indicates at least one emission intensity corresponding to at least one category corresponding to an activity content of the another indirect emission amount.

9. The GHG emission amount derivation apparatus according to claim 8, further comprising:
an extraction unit which extracts, from another existing emission intensity format corresponding to the type of the first activity amount data, at least one set of at least one category and at least one emission intensity related to the another indirect emission amount, the at least one set corresponding to an activity content for which the decision unit is not able to decide at least one emission intensity based on the first emission intensity format among activity contents indicated in the first activity amount data; and
a reception unit which receives, from a user, a set for the activity content for which a decision is not able to be made, from among the at least one set.

10. The GHG emission amount derivation apparatus according to claim 1, wherein
the GHG emission amount includes at least another indirect emission amount indicating a GHG emission amount emitted by an activity of a business operator, the another indirect emission amount not included in an indirect emission amount indicating a GHG emission amount indirectly emitted by a business operator purchasing energy,
the GHG emission amount derivation apparatus further comprising:
an extraction unit which extracts, from an existing emission intensity format corresponding to a type of new activity amount data, at least one set of at least one category and at least one emission intensity related to another indirect emission amount, the at least one set corresponding to each activity content indicated in the new activity amount data; and
a generation unit which generates a new emission intensity format for new activity amount data by specifying, from among the at least one set, one set for each activity content indicated in the new activity amount data according to an instruction of a user.

11. The GHG emission amount derivation apparatus according to claim 10, wherein
the extraction unit
extracts, as the at least one set, a predetermined number of sets in descending order of reliability according to a learning model obtained by machine learning a combination of a type of activity amount data and an activity content which are specified from an existing emission intensity format, and at least one category and at least one emission intensity related to another indirect emission amount, the combination being as training data.

12. A greenhouse gas (GHG) emission amount derivation method comprising:
acquiring, by an acquisition unit, from a storage unit, first activity amount data indicating an activity content and an activity amount for each activity content for which a GHG emission amount is derived;
selecting, by a selection unit, a first emission intensity format corresponding to a type of the first activity amount data from among a plurality of emission intensity formats stored in the storage unit and predetermined for each type of activity amount data, the plurality of emission intensity formats indicating an emission intensity for each activity content;
deciding, by a decision unit, at least one emission intensity for each activity content indicated in the first activity amount data, based on the first emission intensity format; and
deriving, by a derivation unit, a GHG emission amount for each activity amount for each activity content indicated in the first activity amount data, based on the at least one emission intensity.

13. The GHG emission amount derivation method according to claim 12, wherein
the GHG emission amount includes at least another indirect emission amount indicating a GHG emission amount emitted by an activity of a business operator, the another indirect emission amount not included in an indirect emission amount indicating a GHG emission amount indirectly emitted by a business operator purchasing energy, and
when an activity content corresponds to a target of the another indirect emission amount, the emission intensity format indicates at least one emission intensity corresponding to at least one category corresponding to an activity content of the another indirect emission amount, the GHG emission amount derivation method further comprising:
extracting, by an extraction unit, from another existing emission intensity format corresponding to the type of the first activity amount data, at least one set of at least one category and at least one emission intensity related to the another indirect emission amount, the at least one set corresponding to an activity content for which the decision unit is not able to decide at least one emission intensity based on the first emission intensity format among activity contents indicated in the first activity amount data; and
receiving, by a reception unit, from a user, a set for the activity content for which a decision is not able to be made, from among the at least one set.

14. The GHG emission amount derivation method according to claim 12, wherein
the GHG emission amount includes at least another indirect emission amount indicating a GHG emission amount emitted by an activity of a business operator, the another indirect emission amount not included in an indirect emission amount indicating a GHG emission amount indirectly emitted by a business operator purchasing energy,
the GHG emission amount derivation method further comprising:
extracting, by an extraction unit, from an existing emission intensity format corresponding to a type of new activity amount data, at least one set of at least one category and at least one emission intensity related to another indirect emission amount, the at least one set corresponding to each activity content indicated in the new activity amount data; and
generating, by a generation unit, a new emission intensity format for new activity amount data by specifying, from among the at least one set, one set for each activity content indicated in the new activity amount data according to an instruction of a user.

15. The GHG emission amount derivation method according to claim 14, wherein
the extracting includes
extracting, by the extraction unit, as the at least one set, a predetermined number of sets in descending order of reliability according to a learning model obtained by machine learning a combination of a type of activity amount data and an activity content which are specified from an existing emission intensity format, and at least one category and at least one emission intensity related to another indirect emission amount, the combination being as training data.

16. A non-transitory computer-readable medium having stored thereon a program for causing a computer to function as a greenhouse gas (GHG) emission amount derivation apparatus comprising:
an acquisition unit which acquires first activity amount data indicating an activity content and an activity amount for each activity content for which a GHG emission amount is derived;
a selection unit which selects a first emission intensity format corresponding to a type of the first activity amount data from among a plurality of emission intensity formats predetermined for each type of activity amount data, the plurality of emission intensity formats indicating an emission intensity for each activity content;
a decision unit which decides at least one emission intensity for each activity content indicated in the first activity amount data, based on the first emission intensity format; and
a derivation unit which derives a GHG emission amount for each activity amount for each activity content indicated in the first activity amount data, based on the at least one emission intensity.

17. The non-transitory computer-readable medium according to claim 16, wherein
the GHG emission amount includes at least another indirect emission amount indicating a GHG emission amount emitted by an activity of a business operator, the another indirect emission amount not included in an indirect emission amount indicating a GHG emission amount indirectly emitted by a business operator purchasing energy, and
when an activity content corresponds to a target of the another indirect emission amount, the emission intensity format indicates at least one emission intensity corresponding to at least one category corresponding to an activity content of the another indirect emission amount, the non-transitory computer-readable medium having stored thereon a program for causing the computer to function as the GHG emission amount derivation apparatus further comprising:
an extraction unit which extracts, from another existing emission intensity format corresponding to the type of the first activity amount data, at least one set of at least one category and at least one emission intensity related to the another indirect emission amount, the at least one set corresponding to an activity content for which the decision unit is not able to decide at least one emission intensity based on the first emission intensity format among activity contents indicated in the first activity amount data; and
a reception unit which receives, from a user, a set for the activity content for which a decision is not able to be made, from among the at least one set.

18. The non-transitory computer-readable medium according to claim 16, wherein
the GHG emission amount includes at least another indirect emission amount indicating a GHG emission amount emitted by an activity of a business operator, the another indirect emission amount not included in an indirect emission amount indicating a GHG emission amount indirectly emitted by a business operator purchasing energy, the non-transitory computer-readable medium having stored thereon a program for causing the computer to function as the GHG emission amount derivation apparatus further comprising:
an extraction unit which extracts, from an existing emission intensity format corresponding to a type of new activity amount data, at least one set of at least one category and at least one emission intensity related to another indirect emission amount, the at least one set corresponding to each activity content indicated in the new activity amount data; and
a generation unit which generates a new emission intensity format for new activity amount data by specifying, from among the at least one set, one set for each activity content indicated in the new activity amount data according to an instruction of a user.

19. The non-transitory computer-readable medium according to claim 18, wherein
the extraction unit
extracts, as the at least one set, a predetermined number of sets in descending order of reliability according to a learning model obtained by machine learning a combination of a type of activity amount data and an activity content which are specified from an existing emission intensity format, and at least one category and at least one emission intensity related to another indirect emission amount, the combination being as training data.
